(19) United States
(12) Patent Application Publication
(10) Pub. No.: US 2025/0304463 A1
(43) Pub. Date: Oct. 2, 2025

(54) MIXED IONIC ELECTRICAL CONDUCTORS FORMED OF NIOBIUM-BASED MATERIALS FOR BATTERIES AND METHODS OF MAKING SAME

(71) Applicant: Massachusetts Institute of Technology, Cambridge, MA (US)

(72) Inventors: Ju LI, Weston, MA (US); Shitong Wang, Shenyang (CN); Yanhao Dong, Hefei (CN)

(73) Assignee: Massachusetts Institute of Technology, Cambridge, MA (US)

(21) Appl. No.: 18/865,106

(22) PCT Filed: Mar. 13, 2023
(86) PCT No.: PCT/US2023/064209

§ 371 Date: Nov. 12, 2024

Related U.S. Application Data
(60) Provisional application No. 63/341,081, filed on May 12, 2022.

(51) Int. Cl. C01G 41/00; H01M 10/0525

(52) U.S. Cl. CPC C01G 41/006; H01M 10/0525; C01P 2004/62; C01P 2004/82; C01P 2006/16; C01P 2006/40

(57) ABSTRACT

A mixed ionic and electronic conductors (MIEC) material for a battery includes a combination of niobium (Nb), tungsten (W), titanium (Ti), and/or oxygen (O) forming a super-MIEC material with an increased alkali ion metal diffusivity. In one example, the MIEC material is a Nb—W—Ti-0 material with an anion-to-cation ratio ranging from about 2.33 to about 2.8 where the anion is O and the cation is Nb, W, and Ti. The MIEC material may be a coarse-grained material that includes particles consisting essentially of Nb, W, Ti, and/or O and having a dimension of at least 0.1 μm. The MIEC material may have an open pore structure with pores having a pore diameter from about 2.5 Å to about 2.8 Å. The MIEC material may also include carbon (C) that coats each particle. The MIEC material may be incorporated into an anode or a cathode of a lithium-ion battery.

### CROSS-REFERENCE TO RELATED APPLICATION(S)

This application claims the priority benefit, under 35 U.S.C. 119(e), of U.S. Application No. 63/341,081, filed May 12, 2022, which is incorporated herein by reference in its entirety.

### GOVERNMENT SUPPORT

This invention was made with government support under DE-SC0002633 awarded by the U.S. Department of Energy. The government has certain rights in the invention.

### BACKGROUND

Mixed ionic and electronic conductors (MIECs) are useful in solid oxide fuel/electrolysis cells, batteries, electrochromic materials, and neuromorphic computing. A lithium-ion battery (LIB)'s cathode and anode are MIECs. At high depths of discharge (DOD), the battery's anode stores large quantities of Li ions in its lattice interior. High DODs are often accompanied by the redox of certain host elements in the cathode and anode, including transition metals (TMs). Rapid Li⁺ and e⁻ transports (thus effective Li “atomic” diffusivity D_{Li}) maintained at all DODs can facilitate fast charging and high discharge power batteries used in heavy transportation (e.g., boats, trains, and trucks), industrial equipment (e.g., cranes), household products, and electrical-grid regulation.

### SUMMARY

The Inventors have recognized and appreciated that conventional active materials with intrinsically low ionic and/or electronic conductivities (e.g., LiFePO₄ and Li₄Ti₅O₁₂) have typically relied on techniques using nanoengineering to decrease the characteristic lattice diffusion length in the electrode. However, compared to the nano-LiFePO₄ cathode and nano-Li₄Ti₅O₁₂ anode, the Inventors recognized coarse-grained single-crystal oxide electrodes may offer higher packing density, higher volumetric energy and power densities, and less electrochemically active surface area to reduce undesired side reactions. Using single crystal materials may also reduce strain mismatch and stress concentration at grain boundaries, which often induce mechanical and stress-corrosion cracking in polycrystalline electrodes. Single crystal materials may simplify processing, coating, electrode casting and calendaring. Some single crystal active materials can be produced using cost-effective solid-state synthesis. Therefore, micron-sized single crystal active materials may be preferred for fast charging and high discharge power batteries.

However, single crystal active materials that can be used in anodes for fast charging and high discharge power batteries are uncommon. Graphite is not conventionally used because lithium-metal dendrites form on graphite anodes under high-rate conditions. There are some existing super-MIEC active materials, including Nb₂O₅ polymorphs (e.g., T-Nb₂O₅, TT-Nb₂O₅), xNb₂O₅·(1−x)TiO₂ (e.g., Nb₂TiO₇), and xNb₂O₅·(1−x)WO₃ (e.g., Nb₁₈W₁₆O₉₃), but these materials have conventionally reported cycle lives less than 1000 cycles, even when modified with elemental doping. Their cycle lives are far shorter than the nano-Li₄Ti₅O₁₂ anode.

The present disclosure is directed to various inventive MIEC materials that include niobium (Nb), tungsten (W), titanium (Ti), and/or oxygen (O) for use in electrodes of a battery, such as an anode for a secondary lithium-ion battery, methods of making the MIEC material, and methods of using the MIEC material in electrodes and secondary batteries. The MIEC active materials disclosed herein are super-MIECs with high energy density and can be used for high-power applications. The active materials may be polycrystalline or single crystal.

A super-MIEC is a MIEC having an effective activation energy (Q) of lithium ion diffusion (D_{Li}) inside the MIEC that is low enough so that D_{Li} is sufficiently high. For example, D_{Li} may be greater than 10⁻¹⁶ m² s⁻¹. Preferably, D_{Li} is greater than 10⁻¹⁴ m² s⁻¹. More preferably, D_{Li} is greater than 10⁻¹³ m² s⁻¹. For example, if Q is less than 250 meV (or about 10 kBT) at T=300 K, D_{Li} scales with ν_{Li}h_{Li}²e⁻¹⁰ and is equal to about 5×10⁻¹³ m² s⁻¹ with a typical hopping trial frequency ν_{Li}=1 THz and hopping distance h_{Li}=1 Å. In this example, in t=100 seconds at a 36 C charging/discharging rate, the diffusion distance L=(2D_{Li}_{^{t}})^{1/2}=10 μm. 10 μm is also the desirable battery electrode particle size for slurry coating. A super-MIEC with a large DOD range allows fully dense, single-crystal particles of 10 μm size to be used, without using electrolyte infiltration into polycrystalline secondary particles, greatly increasing the volumetric energy density of the anode, and reducing side reactions in the anode during battery operation.

The MIEC material may be a Nb-based material. For example, the MIEC material may be a niobium tungsten titanate (Nb—W—Ti—O) material, which includes Nb, W, Ti, and O elements. In one non-limiting example, Nb may be present in the MIEC material in an amount having a mass percentage from about 0.1% to about 93% relative to the total mass of the MIEC material. W may be present in the MIEC material in an amount having a mass percentage from about 0.10% to about 73% relative to the total mass of the MIEC material. Ti may be present in the MIEC material in an amount having a mass percentage from about 0.1% to about 26% relative to the total mass of the MIEC material. O may be present in the MIEC material in an amount having a mass percentage from about 22% to about 29% relative to the total mass of the MIEC material. In another non-limiting example, Nb may be present in the MIEC material in an amount having a mass percentage from about 0.1% to about 70% relative to the total mass of the MIEC material. W may be present in the MIEC material in an amount having a mass percentage from about 0.1% to about 70% relative to the total mass of the MIEC material. Ti may be present in the MIEC material in an amount having a mass percentage from about 0.1% to about 35% relative to the total mass of the MIEC material. O may be present in the MIEC material in an amount having a mass percentage from about 20% to about 40% relative to the total mass of the MIEC material.

In yet another example, the MIEC material may include Nb, W, and O forming a Nb—W—O material. In yet another example, the MIEC material may include Nb, Ti, and O forming a Nb—Ti—O material. Thus, more generally the MIEC materials disclosed herein may include Nb in an amount having a mass percentage from about 0% to about 93% relative to the total mass of the MIEC material, W in an amount having a mass percentage from about 0% to about 73% relative to the total mass of the MIEC material, Ti in an amount having a mass percentage from about 0% to about 26% relative to the total mass of the MIEC material, and O in an amount having a mass percentage from about 22% to about 29% relative to the total mass of the MIEC material.

In some embodiments, the MIEC material may have a chemical formula of NbₓW_{y}Ti_{z}O_{5x/2+3y+2z}. In one example, x is 0-100, y is 0-80, and z is 0-70, thus covering Nb—W—O, Nb—Ti—O, and Nb—W—Ti—O materials. In another example, x is 20-100, y is 0.1-80, and z is 0.1-70. In some embodiments, the MIEC material may have a chemical formula of Nb₉W_{y}Ti_{z}O_{22.5+3y+2z}, where y is 2-4, and z is 4-6. The MIEC material may have an anion-to-cation ratio (ACR) of (5x/2+3y+2z)/(x+y+z) from about 2.33 to about 2.80.

The MIEC material may be polycrystalline or a single crystalline material. In particular, the MIEC material may be a coarse-grained material where at least some or, in some instances, most of the grains (also referred to herein as “particles”) are polycrystalline or a single crystalline. The particles may further consist essentially of Nb, W, Ti, and O. If single crystalline, the particle may have at least one dimension that is at least 0.1 μm. Preferably, the at least one dimension may be at least 1 μm. More preferably, the at least one dimension may be at least 10 μm. The MIEC material may also have an open pore structure with a plurality of pores where each pore has a pore diameter ranging from about 2.5 Å to about 2.8 Å.

The MIEC material may have an alkali metal ion diffusivity of at least 10⁻¹⁶ m² s⁻¹. More preferably, the alkali metal ion diffusivity may be at least 10⁻¹⁴ m² s⁻¹. The alkali metal ion diffusivity may be a lithium ion diffusivity and the MIEC material may further include lithium (Li) present in an amount having a mass percentage from about 4% to about 12% relative to the total mass of the MIEC material. The MIEC material may further include at least one of boron (B), nitrogen (N), phosphorous (P), or sulfur (S). The particles forming the MIEC material may also be coated with, for example, carbon. In some embodiments, the MIEC material may include carbon (C) in an amount having a mass percentage from about 0.1% to about 20% relative to the total mass of the MIEC material.

In some embodiments, the MIEC material may be incorporated into an anode of a battery. The anode may contain the MIEC material in a mass percentage of at least 85% of the total mass of the anode material. The MIEC material may have a mass loading of about 1.0 mg per cm² to about 20.0 mg per cm². For example, the battery may be a lithium-ion battery. The lithium ion battery may include a cathode comprising at least one of LiCoO₂, LiNi_{0.6}Co_{0.2}Mn_{0.2}O₂, LiNi_{0.5}Co_{0.2}Mn_{0.3}O₂, LiNi_{0.33}Co_{0.33}Mn_{0.33}O₂, LiNi_{0.5}M_{1.5}O₄, or LiFePO₄.

In one example embodiment, a MIEC material has a composition of AᵤNbᵥW_{w}TiₓM_{y}O_{z}, a single-crystal structure, and a lithium diffusivity of at least 10⁻¹⁵ m² s−¹. Preferably, A is an alkali metal, M is at least one of B, N, P, or S, u is 0-10, v is 5-20, w is 1-10, x is 1-10, y is 0-5, and z is 18-110.

In another example embodiment, a MIEC material includes niobium (Nb) in an amount having a mass percentage from about 0.1% to about 93% relative to the total mass of the MIEC material, tungsten (W) in an amount having a mass percentage from about 0.1% to about 73% relative to the total mass of the MIEC material, titanium (Ti) in an amount having a mass percentage from about 0.1% to about 26% relative to the total mass of the MIEC material, and oxygen (O) in an amount having a mass percentage of about 22% to about 29% relative to the total mass of the MIEC material.

In another example embodiment, a MIEC material includes a first amount of oxygen (O) and a second amount of metal, where the metal comprises niobium (Nb) and at least one of tungsten (W) or titanium (Ti). For this MIEC material, a ratio of the first amount to the second amount ranges from about 2.33 to about 2.8 and the MIEC material comprises a plurality of particles consisting essentially of the oxygen and the metal where each particle of the plurality of particles has a single-crystal structure and at least one dimension that is at least 0.1 μm.

In another example embodiment, an anode includes a mixed ionic-electronic conductor (MIEC) having a single-crystal structure (e.g., the MIEC material is a coarse-grained material where the grains are single crystalline) and at least one dimension that is greater than 1 micron. Preferably, the MIEC includes at least two metals, one of which is Nb. Excluding Li atoms, each atom in the single-crystal structure has an average atomic volume greater than 13 Å³. The MIEC material may further comprise a plurality of particles consisting essentially of the oxygen and the metal where each particle of the plurality of particles has a single-crystal structure and at least one dimension that is at least 0.1 μm

In another example embodiment, a method of making a mixed ionic-electronic conductor (MIEC) material includes the steps of mixing a Nb source, a Ti source, and a W source to form a mixture and heating the mixture to a temperature from about 1000° C. to about 1300° C. for a period from about 0.5 hours to about 60 hours to form the MIEC material. Preferably, the Nb source is at least one of Nb₂O₅, NbO₂, NbC, or niobium ethoxide, the Ti source is at least one of anatase TiO₂, rutile TiO₂, or TiO₂—B, and the W source is at least one of WO₃ or WO₂.

For this embodiment, Nb may be present in the mixture in an amount having a mass percentage from about 0.1% to about 93% relative to the total mass of the mixture. W may be present in the mixture in an amount having a mass percentage from about 0.1% to about 73% relative to the total mass of the mixture. Ti may be present in the mixture in an amount having a mass percentage from about 0.1% to about 26% relative to the total mass of the mixture. The MIEC material formed by this method may have a chemical formula of NbₓW_{y}Ti_{z}O_{5x/2+3y-2z} where x is 20-100, y is 0.1-80, and z is 0.1-70. The step of heating the mixture may also form a plurality of particles consisting essentially of Nb, W, Ti, and oxygen (O) in the MIEC material with each particle of the plurality of particles having a single-crystal structure. The particles may further have at least one dimension that is at least 0.1 μm. More preferably, the particles may have at least one dimension that is at least 1 μm. The mixing step may include mixing at least one of a boron (B) source, a nitrogen (N) source, a phosphorous (P) source, or a sulfur (S) source into the mixture.

The method may also include forming a carbon-coated MIEC material where the respective particles of the MIEC material are each coated with carbon. For example, the mixing step may include mixing one or more carbon precursors into the mixture. After heating the mixture to form the MIEC material, a high-temperature carbonization process may be performed where the MIEC material is heated to a temperature from about 200° C. to about 1400° C. for a time period from about 0.5 hours to about 12 hours in a control atmosphere consisting essentially of argon (Ar) or nitrogen (N₂). The one or more carbon precursors may include one or more of graphite, conductive carbon black, carbon nanotubes, carbon nanospheres, carbon nanofibers, carbon gels, sucrose, glucose, fructose, citric acid, ascorbic acid, starch, cellulose, polypropylene, epoxy resin, polyvinylidene fluoride, polytetrafluoroethylene, polystyrene cyanide, phenolic resin, styrene butadiene rubber emulsion, polystyrene, or carboxymethyl cellulose.

In another example embodiment, a method of making a mixed ionic-electronic conductor (MIEC) material includes the steps of mixing a Nb source and at least one of a Ti source or a W source to form a mixture and heating the mixture to a temperature from about 1000° C. to about 1300° C. for a period from about 0.5 hours to about 60 hours to form the MIEC material. Preferably, the Nb source is at least one of Nb₂O₅, NbO₂, NbC, or niobium ethoxide, the Ti source (if used) is at least one of anatase TiO₂, rutile TiO₂, or TiO₂—B, and the W source (if used) is at least one of WO₃ or WO₂. The MIEC material formed by this method may have a chemical formula of NbₓW_{y}Ti_{z}O_{5x/2+3y+2z} where x is 0-100, y is 0-80, and z is 0-70, thus covering Nb—W—O, Nb—Ti—O, and Nb—W—Ti—O materials.

In another example embodiment, a method of using a half-cell battery includes the steps of: (A) charging the half-cell battery to at least 2.5 V vs. Li/Li⁺; (B) discharging the battery to about 1.0 V vs. Li/Li⁺; and repeating steps (A) and (B) for at least 1000 cycles at room temperature. Preferably, the battery has an initial specific discharge capacity of at least about 180 mAh g⁻¹ at 200 mAh g⁻¹. Over the at least 1000 cycles, the battery retains an average specific discharge capacity of at least about 70% of the initial specific discharge capacity. The battery includes an anode and a cathode. The cathode includes a mixed ionic-electronic conductor (MIEC) including Nb₉WₓTi_{y}O_{z} where x is 2-4 and y is 4-6. The anode includes a Li metal. The cathode has a current density of about 100 mAh g⁻¹ to about 16000 mAh g⁻¹.

In another example embodiment, a method of using a battery includes the steps of: (A) charging the battery to at least 3.3 V; (B) discharging the battery to about 1.5 V; and repeating steps (A) and (B) for at least 1000 cycles at room temperature. Preferably, the battery has an initial specific discharge capacity of at least about 1.0 mAh cm⁻². Over the at least 1000 cycles, the battery retains an average specific discharge capacity of at least about 70% of the initial specific discharge capacity. The battery includes an anode and a cathode. The anode includes a mixed ionic-electronic conductor (MIEC) including Nb₉WₓTi_{y}O_{z} where x is 2-4 and y is 4-6.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1 is the calculated pre-zeolite frameworks in the NbO_{2.5}—WO₃—TiO₂ phase diagram. The colored area shows compositions having the Wadsley-Roth structure and with an anion-to-cation ratio (also referred to herein as a O/M ratio) from 2.33 to 2.80.

FIG. 2 shows an example battery that can include at least one of the MIEC materials disclosed herein.

FIG. 3A is a scanning electron micrograph (SEM) of Nb—W—Ti—O-1.

FIG. 3B is an SEM of Nb—W—Ti—O-2.

FIG. 3C is an SEM of Nb—P—O.

FIG. 3D is an SEM of Nb—Ti—O.

FIG. 3E is an SEM of Nb—W—O.

FIG. 4 is the crystallographic structure of Nb—W—Ti—O.

FIG. 5 is an X-ray diffraction (XRD) pattern of Nb—W—Ti—O.

FIG. 6 is the Li-ion diffusion coefficients (D_{Li}) at various states of charge (SOC) in a Nb—W—Ti-1 electrode, a Nb—W—Ti—O-2 electrode, a Nb—P—O electrode, a Nb—Ti—O electrode, and a Nb—W—O electrode as measured by galvanostatic intermittent titration technique (GITT).

FIG. 7 is the gravimetric energy density and electrode density of a Nb—W—Ti—O-1 electrode, a Nb—W—Ti—O-2 electrode, a Nb—P—O electrode, a Nb—Ti—O electrode, and a Nb—W—O electrode.

FIG. 8 is the volumetric energy density and capacity retention of a Nb—W—Ti—O-1 electrode, a Nb—W—Ti—O-2 electrode, a Nb—P—O electrode, a Nb—Ti—O electrode, a Nb—W—O electrode, a Li—Ti—O electrode, and a carbon electrode.

FIG. 9 is the first five galvanostatic discharge/charge profiles and Coulombic efficiencies of a Nb—W—Ti—O-1 electrode.

FIG. 10 is the rate performance of an Nb—W—Ti—O-1 electrode.

FIG. 11 is the cycling performance of the Nb—W—Ti—O-1 electrode in FIG. 9.

FIG. 12 is the first five galvanostatic discharge/charge profiles and Coulombic efficiencies of a Nb—W—Ti—O-2 electrode.

FIG. 13 is the rate performance of a Nb—W—Ti—O-2 electrode.

FIG. 14 is the cycling performance of the Nb—W—Ti—O-2 electrode in FIG. 12.

FIG. 15 is the first five galvanostatic discharge/charge profiles and Coulombic efficiencies of a Nb—P—O electrode.

FIG. 16 is the rate performance of a Nb—P—O electrode.

FIG. 17 is the cycling performance of the Nb—P—O electrode in FIG. 15.

FIG. 18 is the first five galvanostatic discharge/charge profiles and Coulombic efficiencies of a Nb—Ti—O electrode.

FIG. 19 is the rate performance of a Nb—Ti—O electrode.

FIG. 20 is the cycling performance of the Nb—Ti—O electrode in FIG. 18.

FIG. 21 is the first five galvanostatic discharge/charge profiles and Coulombic efficiencies of a Nb—W—O electrode.

FIG. 22 is the rate performance of a Nb—W—O electrode.

FIG. 23 is the cycling performance of the Nb—W—O electrode in FIG. 21.

### DETAILED DESCRIPTION

Following below are more detailed descriptions of various concepts related to, and implementations of, a MIEC material for a battery that includes niobium (Nb), tungsten (W), titanium (Ti), and/or oxygen (O), such as a Nb—W—Ti—O material, an electrode and/or a battery that includes the MIEC material, methods for making the MIEC material, and methods for using the MIEC material in a battery. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive MIEC materials are provided, wherein a given example or set of examples showcases one or more particular features of a material composition, a material morphology, and/or a material property. It should be appreciated that one or more features discussed in connection with a given example of a MIEC material may be employed in other examples of MIEC materials according to the present disclosure, such that the various features disclosed herein may be readily combined in a given MIEC material according to the present disclosure (provided that respective features are not mutually inconsistent).

Certain dimensions and features of the MIEC material are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. A MIEC MATERIAL FOR A BATTERY

The MIEC materials disclosed herein may generally be a Nb-based material. For example, the MIEC material may be a Nb—W—Ti—O material that includes niobium (Nb), tungsten (W), titanium (Ti), and oxygen (O) elements. In another example, the MIEC material may include Nb, W, and O forming a Nb—W—O material. In yet another example, the MIEC material may include Nb, Ti, and O forming a Nb—Ti—O material.

In one non-limiting example, the MIEC material may be a Nb—W—Ti—O material where Nb has a mass percentage in a range from about 0.1% to about 70%, W has a mass percentage in a range from about 0.1% to about 70%, Ti has a mass percentage in a range from about 0.1% to about 35%, and O has a mass percentage in a range from about 20% to about 40%. In another non-limiting example, the MIEC material may be a Nb—W—Ti—O material where Nb has a mass percentage in a range from about 0.1% to about 93%, W has a mass percentage in a range from about 0.1% to about 73%, Ti has a mass percentage in a range from about 0.1% to about 26%, and O has a mass percentage in a range from about 22% to about 29%. More generally, the MIEC material may include O, Nb, and one or both of W and Ti where Nb has a mass percentage in a range from about 0% to about 93%, W has a mass percentage in a range from about 0% to about 73%, Ti has a mass percentage in a range from about 0% to about 26%, and O has a mass percentage in a range from about 22% to about 29%.

The term “about,” when used to describe the mass percentages of the constituent elements in the MIEC material (e.g., Nb, W, Ti, O, B, N, S, P, C), is intended to cover variations in composition during manufacture. For example, “about 73%” can correspond to the following ranges: 71.5% to 74.5% (+/−2% variation), 72.3% to 73.7% (+/−1% variation), 72.42% to 73.58% (+/−0.8% variation), 72.56% to 73.44% (+/−0.6% variation), 72.71% to 73.29% (+/−0.4% variation), 72.85% to 73.15% (+/−0.2% variation), including all values and sub-ranges in between.

In one non-limiting example, the MIEC material may have the chemical formula NbₓW_{y}Ti_{z}O_{5x/2+3y+2z}. In one example, x may be in the range of 20-100, y is in the range of 0.1-80, and z is in the range of 0.1-70. In another example, x may be in the range of 0-100, y is in the range of 0-80, and z is in the range of 0-70, thus covering Nb—W—O, Nb—Ti—O, and Nb—W—Ti—O materials. In some embodiments, the MIEC material may have a chemical formula of Nb₉W_{y}Ti_{z}O_{22.5+3y+2z}, where y is 2-4, and z is 4-6.

An anion-to-cation ratio (ACR) may be defined as the ratio of (5x/2+3y+2z)/(x+y+z) and may be from about 2.33 to about 2.80. Here, the anion is oxygen and the cation is Nb, W, and Ti. More generally, the ACR may be defined as the ratio of the amount of oxygen to the amount of metal in the MIEC material, as discussed below. The term “about,” when used to describe the ACR of the MIEC material, is intended to cover variations in composition during manufacture. For example, “about 2.5” can correspond to the following ranges: 2.45 to 2.55 (+/−2% variation), 2.475 to 2.525 (+/−1% variation), 2.48 to 2.52 (+/−0.8% variation), 2.485 to 2.515 (+/−0.6% variation), 2.49 to 2.51 (+/−0.4% variation), 2.495 to 2.505 (+/−0.2% variation), including all values and sub-ranges in between.

In another example, the MIEC material may be Nb₅₃W₁₂Ti₃₅O₁₂₀, hereafter called Nb—W—Ti—O-1. As another example, the MIEC material may be Nb₅₃W₂₄Ti₂₄O₁₂₆, hereafter call Nb—W—Ti—O-2. As another example, the MIEC material may be Nb₃₈W₅₆Ti₅O₁₃₇. As another example, the MIEC material may be Nb₅₈W₃₇Ti₄O₁₃₂. As another example, the MIEC material may be Nb₇₃W₆Ti₂₁O₁₂₁.

In yet another example, the MIEC material may have a Wadsley-Roth structure. For example, the MIEC material may be a “block” structured oxide of the form, MₓO_{y}, where M is a metal (e.g., Nb, Ti, W) and O is oxygen. This form can be used to represent a series of chemical formulas with one single integer variable n, including M₃ₙO₈ₙ₋₃ for Group A, M₃ₙ₊₁O₈ₙ₋₂ (n odd) for Group B, M₃ₙ₊₁O₈ₙ₋₂ (n even) for Group C, M₃ₙ₊₁O₈ₙ₊₁ for Group D, M₄ₙ₊₁O₁₁ₙ for Group E, and M₅ₙ₊₁O₁₄ₙ₋₁ for Group F. Taking the limiting cases as n→∞, and known small n compositions (e.g., n=3 for Nb₂TiO₇ in Group A, n=7 for Nb₂₂O₅₄ in Group B, n=8 for Nb₂₄TiO₆₂ in Group C, n=3 for Nb₉TPO₂₅ in Group D, n=3 for Nb₁₂WO₃₃ in Group E, and n=4 for Nb₁₆W₅O₅₅ in Group F), an O/M ratio may range from about 2.33 to about 2.8. In some embodiments, the MIEC material may have an O/M ratio equal to 2.5, which may be achieved by alloying WO₃ and TiO₂ with a 1:1 molar ratio into a NbO_{2.5} matrix.

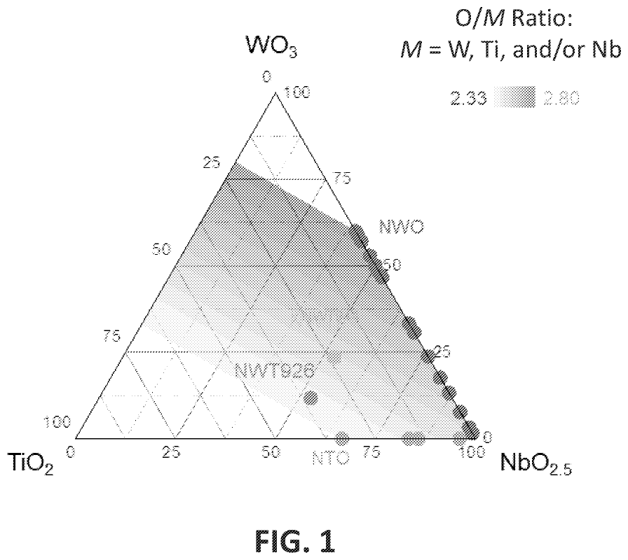

The values for the O/M ratio may be used to define a material space in a NbO_{2.5}—WO₃—TiO₂ ternary phase diagram where materials within the space have a Wadsley-Roth structure and function as a super MIEC, as shown by the shaded area in FIG. 1. Thus, the MIEC materials disclosed herein may include materials in this material space. To reiterate, these MIEC materials may be incorporated into a battery to increase the volumetric energy density and reducing the side reactions. For example, the MIEC material may be Nb₉W₄Ti₄O_{42.5} (NWT944) or Nb₉W₂Ti₆O_{40.5} (NWT926).

The MIEC material may be a single crystal or polycrystalline material. Specifically, the MIEC may be a coarse-grained material that includes a plurality of particles. The particles may have various shapes including, but not limited to, a sphere, an ellipsoid, a polyhedron, and any combination of the foregoing. As a result, each particle may be characterized by one or more dimensions (e.g., a characteristic width, a diameter of a sphere, a major axis and a minor axis of an ellipsoid). The dimensions of the particle may be micrometer sized (e.g., 1 μm to 100 μm) or nanometer sized (1 nm to 999 nm). Preferably, the MIEC material has a particle size with at least one dimension greater than 0.1 μm. More preferably, the MIEC material has a particle size with at least one dimension greater than 1 μm. Even more preferably, the MIEC material has a particle size with at least one dimension of about 10 μm or greater. The term “about,” when used to describe the dimensions of the particles in the MIEC material, is intended to cover variations in particle size during manufacture. For example, “about 1 μm” can correspond to the following ranges: 0.99 μm to 1.01 μm (+/−1% variation), 0.992 μm to 1.008 μm (+/−0.8% variation), 0.994 μm to 1.006 μm (+/−0.6% variation), 0.996 μm to 1.004 μm (+/−0.4% variation), 0.998 μm to 1.002 μm (+/−0.2% variation), including all values and sub-ranges in between.

The MIEC material may have a high alkali metal ion diffusivity (D_{M}) of at least 10⁻¹⁶ m² s⁻¹. Preferably, the MIEC material has a D_{M} that is greater than or equal to 10⁻¹⁴ m² s⁻¹. More preferably, the MIEC material has a D_{M} that is 10₋₁₃ m² s−¹ or higher. In some embodiments, the metal ion, M, may be lithium. The MIEC material may have an open pore structure with pore diameters of about 2.5 Å to about 2.8 Å. This pore diameter may exclude molecules (including water) while providing the rapid D_{Li} described above. This D_{Li} supports high rate charging up to about 30 C. The MIEC material reduces contact and side reactions with the electrolyte and enhances cycle life up to about 10,000 cycles. The large free volume in the MIEC material from the open pore structure may give rise to other structural and physical properties (e.g., surprisingly low coefficient of thermal expansion (CTE) and/or formation of planar defects, which may buffer strain and facilitate transport during electrochemical cycling). The term “about,” when used to describe the pore diameter of the MIEC material, is intended to cover variations in morphology during manufacture. For example, “about 2.5 Å” can correspond to the following dimensional ranges: 2.475 Å to 2.525 Å (+/−1% variation), 2.48 Å to 2.52 Å (+/−0.8% variation), 2.485 Å to 2.515 Å (+/−0.6% variation), 2.49 Å to 2.51 Å (+/−0.4% variation), 2.495 Å to 2.505 Å (+/−0.2% variation), including all values and sub-ranges in between.

The MIEC material may further include at least one of boron (B), nitrogen (N), phosphorous (P), or sulfur (S). For example, the MIEC material may have a composition of AᵤNbᵥW_{w}TiₓM_{y}O_{z}, a single-crystal structure (e.g., the particles forming the MIEC material are single crystalline), and a lithium diffusivity of at least 10⁻¹⁵ m² s⁻¹. Preferably, A is an alkali metal, M is at least one of B, N, P, or S, u is 0-10, v is 5-20, w is 1-10, x is 1-10, y is 0-5, and z is 18-110.

The particles in the MIEC material may also be coated with, for example, carbon. In some embodiments, the MIEC material may include carbon (C) in an amount having a mass percentage from about 0.1% to about 20% relative to the total mass of the MIEC material. The carbon coating may be formed, in part, using a high-temperature carbonization process, which is described below in further detail.

The MIEC material may be formed by mixing together metal oxide powders containing the constituent elements of the MIEC material and then applying a high-temperature heat treatment to the mixture to form and grow particles that comprise the desired composition of Nb, W, Ti, and/or O. For example, a MIEC material that includes Nb, W, Ti, and O may be formed by first mixing a Nb source, a Ti source, and a W source to form a mixture. The Nb source may include, but is not limited to, Nb₂O₅, NbO₂, NbC, and/or niobium ethoxide. The Ti source may include, but is not limited to, anatase TiO₂, rutile TiO₂, and/or TiO₂—B. The W source may include, but is not limited to, WO₃ and/or WO₂. The mixture of metal oxide powders may then be heated to a temperature from about 1000° C. to about 1300° C. for a period from about 0.5 hours to about 60 hours.

The term “about,” when used to describe the temperature of the heat-treatment process to form a MIEC material, is intended to cover variations in operating temperature that may arise during manufacture and/or when using different equipment to perform the heat-treatment process. For example, “about 1000° C.” can correspond to the following temperature ranges: 990° C. to 1010° C. (+/−1% variation), 992° C. to 1008° C. (+/−0.8% variation), 994° C. to 1006° C. (+/−0.6% variation), 996° C. to 1004° C. (+/−0.4% variation), 998° C. to 1002° C. (+/−0.2% variation), including all values and sub-ranges in between. The term “about,” when used to describe the period of time the heat-treatment process (or the high-temperature carbonization process described below) is applied to the mixture, is intended to cover variations in timing that may arise due to, for example, the heat-treatment process being manually timed or variations in any timing equipment that may be used to perform the heat-treatment process. For example, “about 1 hour” can correspond to the following ranges: 0.99 hours to 1.01 hours (+/−1% variation), 0.992 hours to 1.008 hours (+/−0.8% variation), 0.994 hours to 1.006 hours (+/−0.6% variation), 0.996 hours to 1.004 hours (+/−0.4% variation), 0.998 hours to 1.002 hours (+/−0.2% variation), including all values and sub-ranges in between.

The carbon coating may be formed by mixing various metal oxide powders (e.g., the Nb source, the W source, and the Ti source) together with a carbon precursor. After the high-temperature heat treatment to form the MIEC material, the MIEC material may be subjected to a high-temperature carbonization process where the mixture is heated to a temperature from about 200° C. to about 1400° C. for a time period from about 0.5 hours to about 12 hours in a control atmosphere of argon (Ar) or nitrogen (N₂). This process thus forms a carbon coating on the particles forming the MIEC material. The carbon precursors may include various carbon-based materials including, but not limited to, graphite, conductive carbon black, carbon nanotubes, carbon nanospheres, carbon nanofibers, carbon gels, sucrose, glucose, fructose, citric acid, ascorbic acid, starch, cellulose, polypropylene, epoxy resin, polyvinylidene fluoride, polytetrafluoroethylene, polystyrene cyanide, phenolic resin, styrene butadiene rubber emulsion, polystyrene, carboxymethyl cellulose, and any combinations of the foregoing.

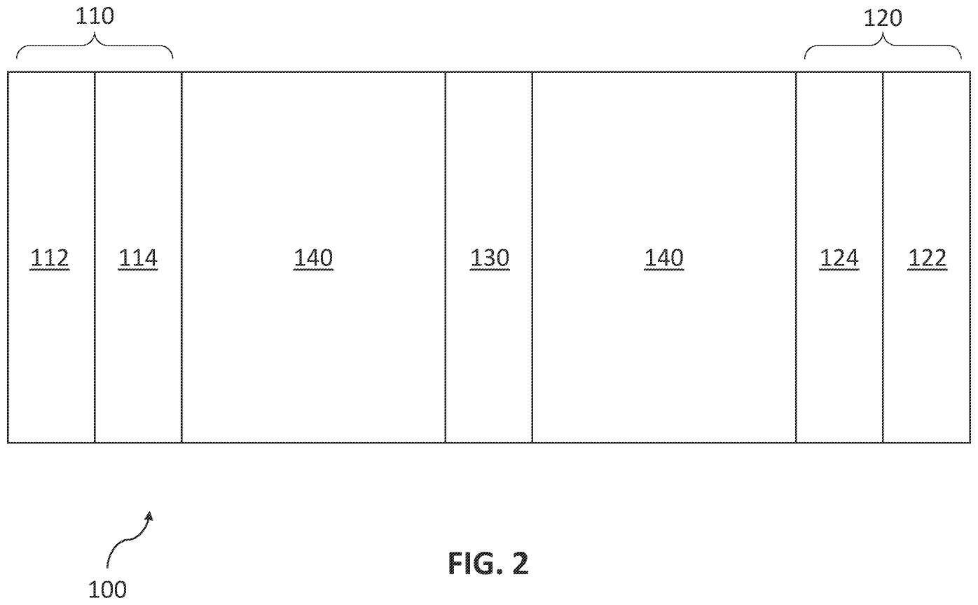

As described above, the MIEC materials disclosed herein may be incorporated into a battery. For example, a lithium-ion battery may include at least one of the above-disclosed MIEC materials. FIG. 2 shows an example battery 100, which includes a cathode 110, an anode 120, a separator 130, and an electrolyte 140. The cathode 110 and the anode 120 may be separated by the separator 130. The electrolyte 140 may be sandwiched between the cathode 110 and the anode 120 and may conduct lithium ions between the cathode 110 and the anode 120.

The cathode 110 includes a cathode current collector 112 and a cathode material layer 114. The cathode current collector 112 can be used to support the cathode material layer 114 and conduct current. The shape of the cathode current collector 112 can be a sheet shape or network shape. The cathode current collector 112 can be formed from various materials including, but not limited to, aluminum, titanium, and stainless steel. The cathode material layer 114 can be disposed on at least one surface of the cathode current collector 112.

The anode 120 includes an anode current collector 122 and an anode material layer 124. The anode current collector 122 can be used to support the anode material layer 124 and conduct current. The anode current collector 122 can be formed in various shapes including, but not limited to, a sheet shape and a network shape. The anode current collector 122 can be formed from various materials including, but not limited to, copper, nickel, and stainless steel. The anode material layer 124 can be disposed on at least one surface of the anode current collector 122.

In one embodiment, the cathode material layer 114 includes at least one of the above-disclosed MIEC materials as a cathode active material. In this embodiment, the anode material layer 124 includes an anode active material (e.g., graphite) having an electrical potential lower than the MIEC material used as a cathode active material.

In another embodiment, the anode material layer 124 includes at least one of the above-disclosed MIEC materials as an anode active material. In this embodiment, the cathode material layer 114 includes a cathode active material. The cathode active material 114 may be a lithium transition metal oxide (e.g., lithium cobalt oxide, lithium nickel oxide, lithium manganese oxide, lithium iron phosphate, and/or lithium manganese phosphate), having an electrical potential higher than that of the MIEC material. In some embodiments, the lithium transition metal oxide may include at least one of LiCoO₂, LiNi_{0.6}Co_{0.2}Mn_{0.2}O₂, LiNi_{0.5}Co_{0.2}Mn_{0.3}O₂, LiNi_{0.33}Co_{0.33}Mn_{0.33}O₂, LiNi_{0.5}M_{1.5}O₄, or LiFePO₄.

The anode material layer 124 and cathode material layer 114 can further include a conducting agent and/or a binder. In the cathode material layer 114, the cathode active material, the conducting agent, and the binder can be uniformly mixed. In the anode material layer 124, the anode active material, the conducting agent, and the binder can be uniformly mixed. The conducting agent can be one or more carbonaceous materials including, but not limited to, carbon black, conducting polymers, acetylene black, carbon fibers, carbon nanotubes, and graphite. The binder can be at least one of polyvinylidene fluoride (PVDF), polyvinylidene difluoride, polytetrafluoroethylene (PTFE), fluoro rubber, ethylene propylene diene monomer, and styrene-butadiene rubber (SBR). In another embodiment, the cathode material layer 114 can be lithium metal.

In another example embodiment, the anode material layer 124 may only include one of the above-disclosed MIEC materials as an anode active material. The anode material layer 124 may have no conducting agent because MIEC materials may have intrinsically high electrical conductivities.

In another embodiment, the cathode material layer 114 may only include one of the above-disclosed MIEC materials as a cathode active material. The cathode material layer 114 may have no conducting agent because MIEC materials have intrinsically high electrical conductivities.

More generally, the anode material layer 124 or the cathode material layer 114 may contain the MIEC material in a mass percentage of at least 85% of the total mass of the anode material layer 124 or the cathode material layer 114. The MIEC material may have a mass loading of about 1.0 mg per cm² to about 20.0 mg per cm² in the anode material layer 124 or the cathode material layer 114. The term “about,” when used to describe the mass loading of the MIEC material in an anode or a cathode, is intended to cover variations in composition during manufacture. For example, “about 1.0 mg per cm²” can correspond to the following ranges: 0.98 mg per cm² to 1.02 mg per cm² (+/−2% variation), 0.99 mg per cm² to 1.01 mg per cm² (+/−1% variation), 0.992 mg per cm² to 1.008 mg per cm² (+/−0.8% variation), 0.994 mg per cm² to 1.006 mg per cm² (+/−0.6% variation), 0.996 mg per cm² to 1.004 mg per cm² (+/−0.4% variation), 0.998 mg per cm² to 1.002 mg per cm² (+/−0.2% variation), including all values and sub-ranges in between.

The separator 130 may be formed from various materials including, but not limited to, a polyolefin microporous membrane, modified polypropylene fabric, polyethylene fabric, glass fiber fabric, superfine glass fiber paper, vinylon fabric, and composite membrane of nylon fabric and wettable polyolefin microporous membrane composited by welding or bonding. The polyolefin porous membrane may be selected from a polypropylene porous membrane, a polyethylene porous membrane, or a lamination of a polypropylene porous membrane and a polyethylene porous membrane.

The electrolyte 140 may include a lithium salt and a non-aqueous solvent dissolving the lithium salt. The lithium salt may be at least one of LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, Li(C₆H₅)₄, and LiCF₃SO₃. The non-aqueous solvent may be at least one of ethylene carbonate, propylene carbonate, butylene carbonate, gamma-butyrolactone, dipropyl carbonate, N-methyl pyrrolidone, N-methylformamide, N-methylacetamide, N,N-dimethylformamide, N,N-diethylformamide, acetonitrile, succinonitrile, 1,4-dicyanobutane, glutaronitrile, dimethyl sulfoxide, dimethyl sulfite, vinylene carbonate, ethylmethyl carbonate, dimethyl carbonate, diethyl carbonate, 4-fluoro-1,3-dioxolan-2-one, chloropropylene carbonate, anhydride, sulfolane, methoxymethylsulfone, tetrahydrofuran, 2-methyltetrahydrofuran, epoxy propane, methyl acetate, ethyl acetate, methyl butyrate, ethyl propionate, methyl propionate, 1,3-dioxolane, acetal, 1,2-dimethoxyethane, and 1,2-dibutyldi.

### 2. EXAMPLE DEMONSTRATIONS OF MIEC MATERIALS

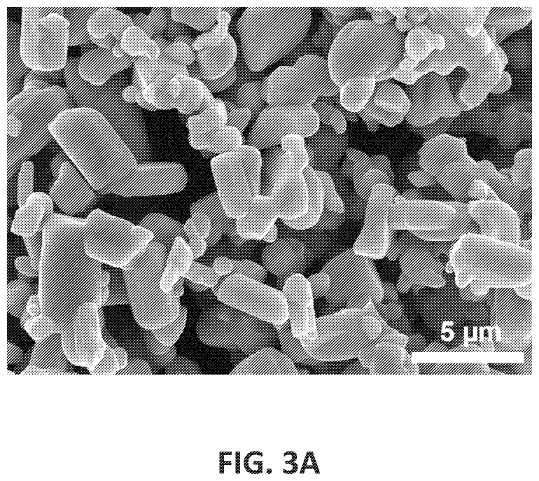

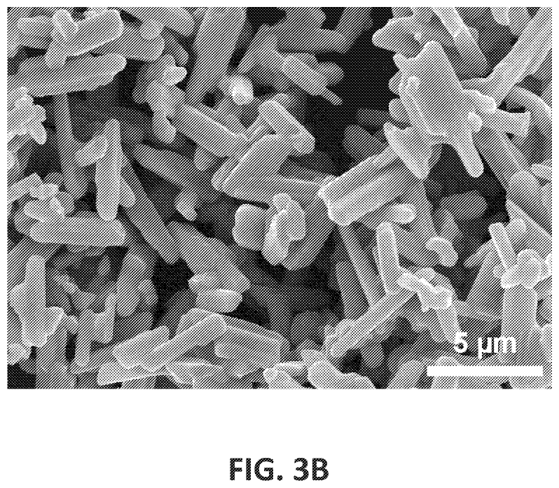

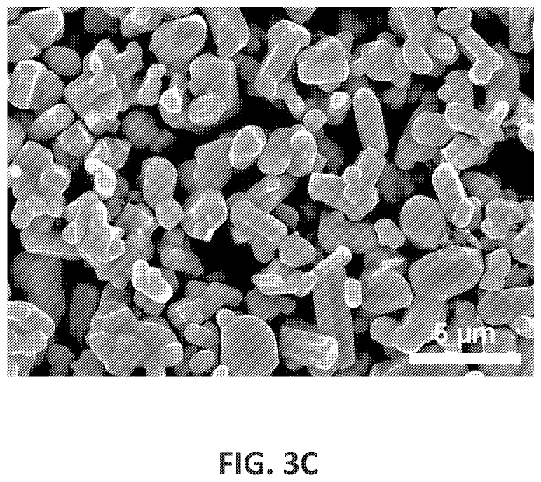

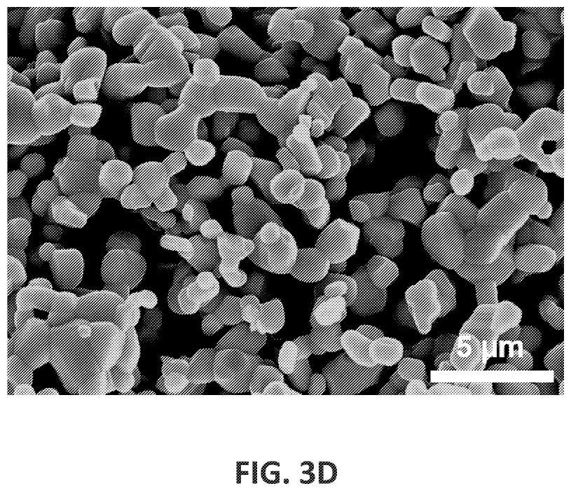

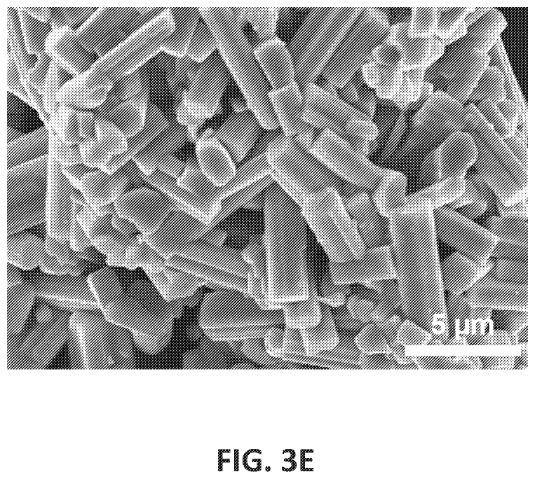

This section provides several example MIEC materials that were synthesized and characterized. Nb-based materials were fabricated using solid-state synthesis. FIG. 3A shows the scanning electron microscopy (SEM) image of Nb—W—Ti—O-1. NbC, anatase TiO₂, and WO₃ were mixed with a molar ratio of Nb:W:Ti=53:12:35, followed by high-temperature heat treatment at about 1100° C. to about 1125° C. for 20 hours. A heating rate of 2° C. min⁻¹ and furnace cooling were used in the heat treatment processes. The heat treatment results in materials with particle sizes with micrometer dimensions. The synthesized material was denoted Nb—W—Ti—O-1 (Nb₅₃W₁₂Ti₃₅O₁₂₀).

FIG. 3B shows the SEM image of Nb—W—Ti—O-2. NbC, anatase TiO₂, and WO₃ were mixed with a molar ratio of Nb:W:Ti=53:24:24, followed by high-temperature heat treatment at about 1100° C. to about 1125° C. for 20 hours. The heating rate of 2° C. min⁻¹ and furnace cooling were used in the heat treatment processes. The synthesized material was denoted Nb—W—Ti—O-2 (Nb₅₃W₂₄Ti₂₄O₁₂₆).

As another example, Nb₂O₅, rutile TiO₂, and WO₃ were mixed with a molar ratio of Nb:W:Ti=38:56:5, followed by high-temperature heat treatment at 1300° C. for 60 hours. The heating rate of 2° C. min⁻¹ and furnace cooling were used in the heat treatment processes. The synthesized material was denoted Nb—W—Ti—O-3 (Nb₃₈W₅₆Ti₅O₁₃₇).

As another example, NbC, rutile TiO₂, and WO₂ were mixed with a molar ratio of Nb:W:Ti=58:37:4, followed by high-temperature treatment at 1150° C. for 40 hours. The heating rate of 2° C. min⁻¹ and furnace cooling were used in the heat treatment processes. The synthesized material was denoted Nb—W—Ti—O-4 (Nb₅₈W₃₇Ti₄O₁₃₂).

As another example, niobium ethoxide, TiO₂—B, and WO₂ were mixed with a molar ratio of Nb:W:Ti=73:6:21, followed by high-temperature heat treatment at 1250° C. for 0.5 h. The heating rate of 2° C. min⁻¹ and furnace cooling were used in heat treatment processes. The synthesized material was denoted Nb—W—Ti—O-5 (Nb₇₃W₆Ti₂₁O₁₂₁).

As another example, Nb—W—Ti—O-1 were mixed with glucose solution (the mass ratio of glucose is 5%) followed by heat treatment at 600° C. for 0.5 h under Ar atmosphere. The heating rate of 2° C. min⁻¹ and furnace cooling were used in heat treatment processes. The synthesized material was denoted Nb—W—Ti—O-1@C.

As another example, Nb—W—Ti—O-3 were mixed with certain amounts of dopamine hydrochloride (the mass ratio of dopamine hydrochloride is 25%) with the tris-buffer (pH≈8.5), followed by heat treatment at 600° C. for 6 h under Ar atmosphere. The heating rate of 5° C. min⁻¹ and furnace cooling were used in heat treatment processes. The synthesized material was denoted Nb—W—Ti—O-3@C.

Several materials were compared to the example MIEC materials synthesized above, including Nb₉PO₂₅ (also called Nb—P—O-1), Nb₂TiO₇ (also called Nb—Ti—O-1), and Nb₁₈W₁₆O₉₃ (also called Nb—W—O-1).

FIG. 3C is an SEM of Nb—P—O-1. Nb₂O₅ and P were mixed with a molar ratio of Nb:P=9:1.1, followed by heat treatment at 1100° C. for 20 hours. The heating rate of 2° C. min⁻¹ and furnace cooling were used in the heat treatment processes. The synthesized material was denoted Nb—P—O-1 (Nb₉PO₂₅).

FIG. 3D is an SEM of Nb—Ti—O-1. Nb₂O₅ and TiO₂ were mixed with a molar ratio of Nb:Ti=2:1, followed by heat treatment at 1125° C. for 5 hours. The heating rate of 2° C. min⁻¹ and furnace cooling were used in the heat treatment processes. The synthesized material was denoted Nb—Ti—O-1 (Nb₂TiO₇).

FIG. 3E is an SEM of Nb—W—O-1. Nb₂O₅ and WO₃ were mixed with a molar ratio of Nb:W=9:8, followed by high-temperature treatment at 1100° C. for 20 hours. The heating rate of 2° C. min⁻¹ and furnace cooling were used in heat treatment processes. The synthesized material was denoted Nb—W—O-1 (Nb₁₈W₁₆O₉₃).

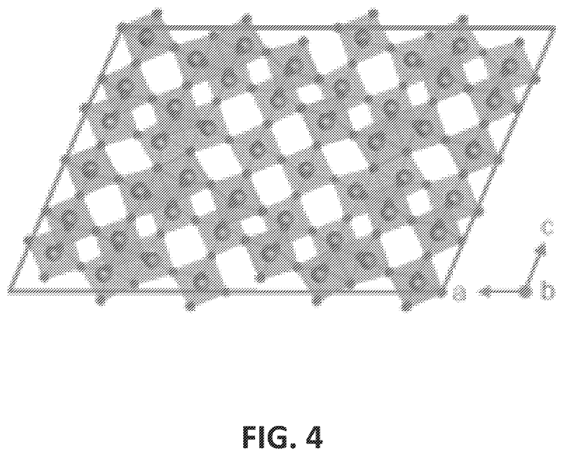

FIG. 4 is the crystallographic structure of Nb—W—Ti—O-1. The crystallographic structural phase is monoclinic. The space group is C2/c (No. 15) with 162 atoms per unit cell. The lattice parameters were a=31.439 Å, b=3.866 Å, c=20.901 Å, α=90.000°, β=112.990°, γ=90.000°, and V=2338.516 Å³. The average atomic volume (defined as supercell volume divided by the number of atoms in the supercell) of Nb—W—Ti—O-1 was about 13.2 Å³ to about 14.4 Å³.

The coefficient of thermal expansion (CTE) of the synthesized MIEC samples was measured using in situ XRD measurements conducted at 100 K t about 650 K. The linear CTE α was obtained from the refined primary-cell volume V₀(T). Compared to the CTE database for 260 compounds centered around ˜7×10⁻⁶ K⁻¹, the synthesized MIEC samples all had negative or close-to-zero CTEs. For example, Nb—W—Ti—O-1 had negative CTEs along all three lattice axes, which is rare and termed isotropic negative CTE. Such anomalously low CTEs may support surface-like adsorption and diffusion of Li⁺ in these materials.

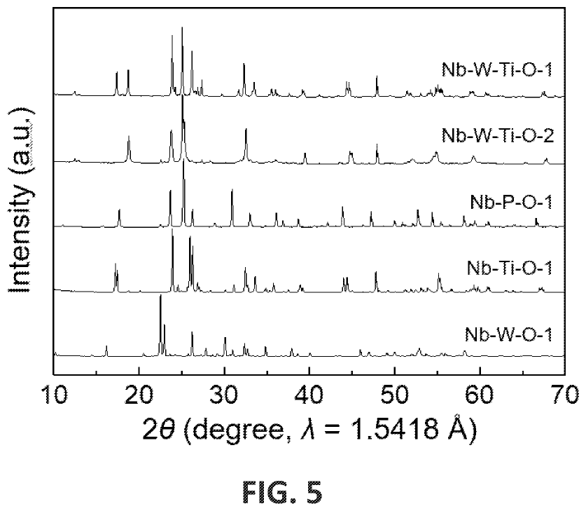

FIG. 5 is the X-ray diffraction (XRD) patterns of Nb—W—Ti—O-1, Nb—W—Ti—O-2, Nb—P—O-1, Nb—Ti—O-1, and Nb—W—O-1. The high-energy XRD data were collected using the 11-ID-C beamline at Advanced Photon Source (APS) of Argonne National Laboratory (ANL), with the X-ray wavelength of 0.1173 Å. Si (113) single crystal was used as a monochromator for an X-ray beam at 105.7 keV. In a typical data collection, the Nb—W—Ti—O-1 powder sample was loaded into a 3 mm capillary with a data acquisition time of 20 minutes. The background was extracted from the same empty capillary. A two-dimensional Perkin-Elmer detector was used to record the scattering patterns in transmission mode. Fit 2D software was applied to calibrate the scattering patterns with the CeO₂ standard sample and integrate the 2D patterns into 1D profiles. The G(r) function was computed by Fourier transform of reduced structural function (F(Q), up to 17.6 Å⁻¹) with PDFgetX2 software. The Rietveld method was used to determine the crystal structure of Nb—W—Ti—O-1 using Foolproof software. A monoclinic C2/c unit cell was built to describe the XRD pattern. The pseudo-Voigt peak-shape function was used to fit the full width at half maximum (FWHM) with fitting parameters U, V, W, and Gaussian/Lorentz ratio.

### 3. EXAMPLE ELECTRODE PREPARATION AND BATTERY ASSEMBLY

The Nb—W—Ti—O-1, conducting carbon black (super P), and binder (sodium carboxymethyl cellulose (CMC) and polymerized styrene-butadiene rubber (SBR) in a weight ratio of 1:1) having a mass ratio of 85:9:6 were added into water solvent, and mixed to obtain a slurry. The slurry was applied on an Al foil as the current collector and dried at 100° C. in a vacuum to obtain an Nb—W—Ti—O-1 electrode.

A 2032-coin type lithium-ion battery was assembled in a glove box using lithium metal as the anode, the prepared Nb—W—Ti—O-1 electrode as the cathode, Celgard 2400 polypropylene porous film as the separator, and a solution of lithium hexafluorophosphate (LiPF₆) in ethylene carbonate (EC), dimethyl carbonate (DMC), and ethyl methyl carbonate (EMC) in a 1:1:1 volume ratio as an electrolyte. The concentration of the LiPF₆ in the solution was about 1 mol/L. The glove box was filled with argon gas. Water and oxygen gas in the glove box were both lower than 1 ppm.

A Nb—W—Ti—O-2 electrode was made using the same method as above, except that the Nb—W—Ti—O-1 was replaced by the Nb—W—Ti—O-2. A 2032-coin type lithium-ion battery was assembled by using the same method as described above with respect to Nb—W—Ti—O-1, except that the Nb—W—Ti—O-1 electrode was replaced by the Nb—W—Ti—O-2 electrode.

For comparison, an Nb—P—O-1 electrode was made using the same method described above, except that the Nb—W—Ti—O-1 was replaced by the Nb—P—O-1. A 2032-coin type lithium-ion battery was assembled using the same method described above except that the Nb—W—Ti—O-1 electrode was replaced by the Nb—P—O electrode.

For comparison, an Nb—Ti—O-1 electrode was made using the same method described above, except that the Nb—W—Ti—O-1 was replaced by the Nb—Ti—O-1. A 2032-coin type lithium-ion battery was assembled using the same method as above except that the Nb—W—Ti—O-1 electrode was replaced by the Nb—Ti—O-1 electrode.

For comparison, an Nb—W—O-1 electrode is made using the same method described above, except that the Nb—W—Ti—O-1 was replaced by the Nb—W—O-1. A 2032-coin type lithium-ion battery was assembled using the same method as above except that the Nb—W—Ti—O-1 electrode was replaced by the Nb—W—O-1 electrode.

For comparison, a commercially-acquired Li₄Ti₅O₁₂, conducting carbon black (super P), and polyvinylidene fluoride binder (PVDF) having a mass ratio of 85:7.5:7.5 were added into N-methyl-2-pyrrolidone (NMP) solvent, and mixed to obtain a slurry. The slurry was applied on a Cu foil as the current collector and dried at 100° C. in a vacuum to obtain a Li—Ti—O electrode. A 2032-coin type lithium-ion battery was assembled using the same method as above except that the Nb—W—Ti—O-1 electrode was replaced by the Li—Ti—O electrode.

For comparison, commercially-acquired meso-carbon microbeads, conducting carbon black (super P), and polyvinylidene fluoride binder (PVDF) having a mass ratio of 90:5:5 were added into N-methyl-2-pyrrolidone (NMP) solvent, and mixed to obtain a slurry. The slurry was applied on a Cu foil as the current collector and dried at 100° C. in a vacuum to obtain a carbon electrode. A 2032-coin type lithium-ion battery was assembled using the same method as above except that the Nb—W—Ti—O-1 electrode was replaced by the carbon electrode.

The electrode densities of the above electrodes were measured. The electrode densities were 3.3 g cm⁻³ for the Nb—W—Ti—O-1 electrode, 3.2 g cm⁻³ for the Nb—W—Ti—O-2 electrode, 3.3 g cm⁻³ for the Nb—P—O electrode, 2.7 g cm⁻³ for the Nb—Ti—O electrode, 3.8 g cm⁻³ for the Nb—W—O electrode, 2.5 g cm⁻³ for the Li—Ti—O electrode, and 2.0 g cm⁻³ for the carbon electrode. The results demonstrated that the electrode density of super-MIEC Nb-based electrodes is greatly enhanced compared to the two representative commercial high rate anodes, Li—Ti—O electrode, and carbon electrode. The higher electrode density in the super-MIEC Nb-based electrodes may increase electrode energy density.

### 4. EXAMPLE ELECTROCHEMICAL PERFORMANCE

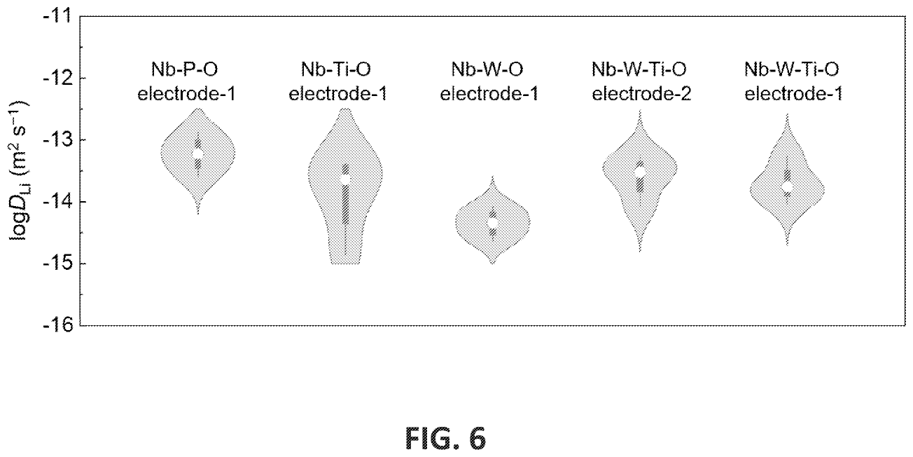

FIG. 6 is the Li-ion diffusion coefficients (D_{Li}) at various states of charge (SOC) in a Nb—W—Ti—O-1 electrode, a Nb—W—Ti—O-2 electrode, a Nb—P—O-1 electrode, a Nb—Ti—O-1 electrode, and a Nb—W—O-1 electrode as measured by galvanostatic intermittent titration technique (GITT). The calculated D_{Li} values from GITT measurements were within the range of about 10⁻¹ m² s−¹ about 10⁻¹² m² s−¹ for all the electrodes. These values are comparable to D_{Li} of 10⁻¹⁶˜10⁻¹² m² s⁻¹ for LiCoO₂ and LiNi_{0.33}Co_{0.33}Mn_{0.33}O₂. In addition to their high D_{Li}, the the synthesized MIEC samples also have intrinsically high electrical conductivities to assist electronic percolation.

Charge/discharge tests and GITT were conducted at varied current densities using a LAND battery testing system (CT-2001A).

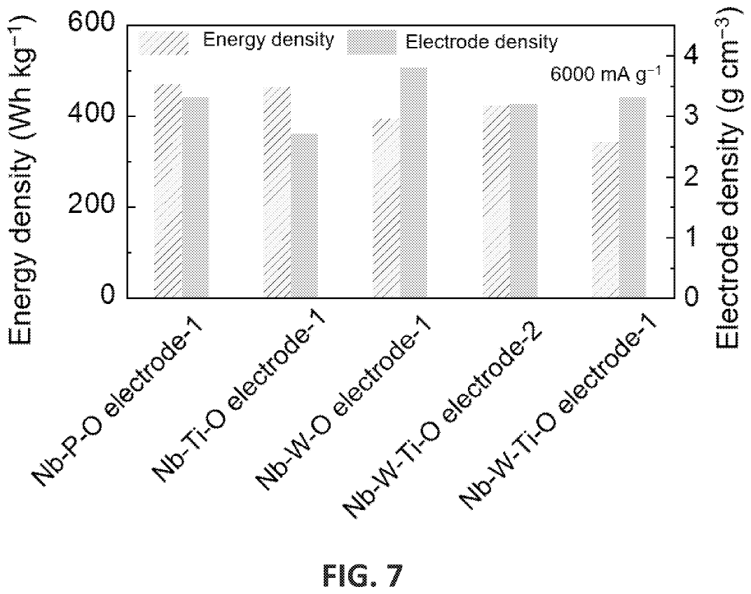

FIG. 7 shows the gravimetric energy density and electrode density of a Nb—W—Ti—O-1 electrode, a Nb—W—Ti—O-2 electrode, a Nb—P—O electrode, a Nb—Ti—O electrode, and a Nb—W—O electrode. The gravimetric energy density and electrode density of the Nb—W—Ti—O electrodes were compared to the other electrodes. The Nb—W—Ti—O electrodes had similar gravimetric energy densities as compared to Li₄Ti₅O₁₂.

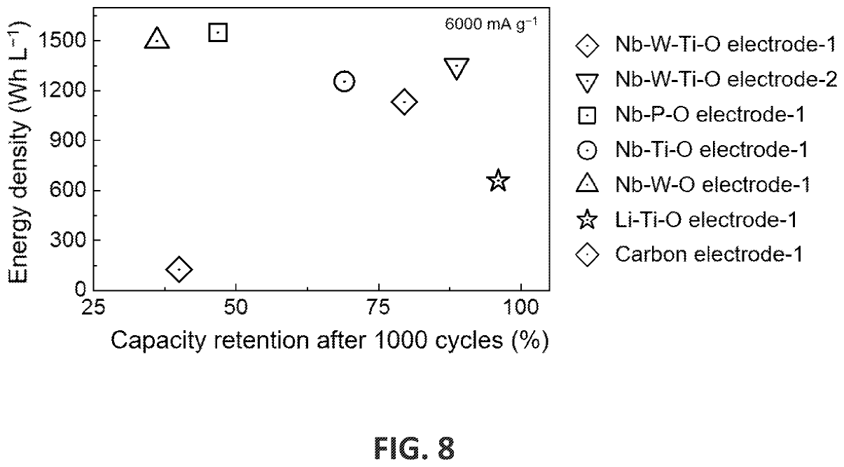

FIG. 8 shows the volumetric energy density and capacity retention of the Nb—W—Ti—O-1 electrode, the Nb—W—Ti—O-2 electrode, the Nb—P—O electrode, the Nb—Ti—O electrode, the Nb—W—O electrode, the Li—Ti—O electrode, and the carbon electrode. The Nb—W—Ti—O electrodes had a volumetric energy density of about 1128 Wh L⁻¹ to about 1550 Wh L⁻¹ (at 6,000 mA g⁻¹). The volumetric energy densities of the electrodes were, from highest to lowest, Nb—P—O electrode, Nb—W—O electrode, Nb—W—Ti—O-2 electrode, Nb—Ti—O electrode-1, and Nb—W—Ti—O-1 electrode. These values are much higher than 658 Wh L⁻¹ for Li₄Ti₅O₁₂ (Li—Ti—O electrode-1) and 127 Wh L⁻¹ for meso-carbon microbeads (carbon electrode-1).

Table 1 compares particle size, electrode density, and initial Coulombic efficiency of Nb—W—Ti—O electrodes to other types of electrodes.

TABLE 1

| | Characterized | Electrode | Initial |
|---|---|---|---|
| | particle | density | Coulombic |
| Materials | size (μm) | (g cm⁻³) | efficiency (%) |
| Nb—P—O | 1~3 | 3.3 | 97.2 |
| Ti—Nb—O | ~1 | 2.7 | 97.3 |
| Nb—W—O | 2~10 | 3.8 | 94.8 |
| Nb—W—Ti—O-1 | 1~3 | 3.2 | 96.5 |
| Nb—W—Ti—O-2 | 1~2 | 3.3 | 96.0 |
| Li₄Ti₅O₁₂ | 0.8~3.0 | 2.5 | 97.0 |
| Meso-carbon | 16~19 | 2.0 | 88.5 |
| microbeads | | | |

Table 2 compares the electrochemical properties of the Nb—W—Ti—O-1 electrode, the Nb—W—Ti—O-2 electrode, the Nb—P—O electrode, the Nb—Ti—O electrode, and the Nb—W—O electrode. Capacity was measured at 200 mA g⁻¹. Rate retention was defined as the ratio of capacity at 6,000 mA g⁻¹ (12 mA cm⁻²) to capacity at 200 mA g⁻¹. Voltage was defined as average discharge voltage at 200 mA g⁻¹. Gravimetric and volumetric energy density were defined as the anode side (including active material, conductive carbon, and binder) in full cells using LiNi_{0.5}Mn_{1.5}O₄ in the cathode and the Nb-based electrodes in the anode. Cyclability was defined as capacity retention after 1,000 cycles at 12 mA cm⁻² (˜60 C), which is a high rate.

TABLE 2

| | | | | | | Capacity |
|---|---|---|---|---|---|---|
| | | | | Gravimetric | Volumetric | retention |
| | Capacity | Rate | | energy | energy | after 1000 |
| | at 200 mA | retention | Voltage | density at | density at | cycles at |
| | g⁻¹ (mAh | at 6,000 mA | (V vs. | 6,000 mA g⁻¹ | 6,000 mA | 6,000 mA |
| Materials | g⁻¹) | g⁻¹ (%) | Li⁺/Li) | (Wh kg⁻¹) | g⁻¹ (Wh L⁻¹) | g⁻¹ (%) |
| Nb—W—Ti—O electrode-1 | 187.1 | 59.0 | 1.57 | 343 | 1,133 | 79.5 |
| Nb—W—Ti—O electrode-2 | 204.2 | 67.4 | 1.62 | 422 | 1,350 | 88.7 |
| Nb—P—O electrode-1 | 209.9 | 69.4 | 1.53 | 470 | 1,550 | 46.8 |
| Nb—Ti—O electrode-1 | 236.3 | 60.1 | 1.50 | 465 | 1,256 | 69.0 |
| Nb—W—O electrode-1 | 180.2 | 69.6 | 1.68 | 394 | 1,499 | 36.1 |

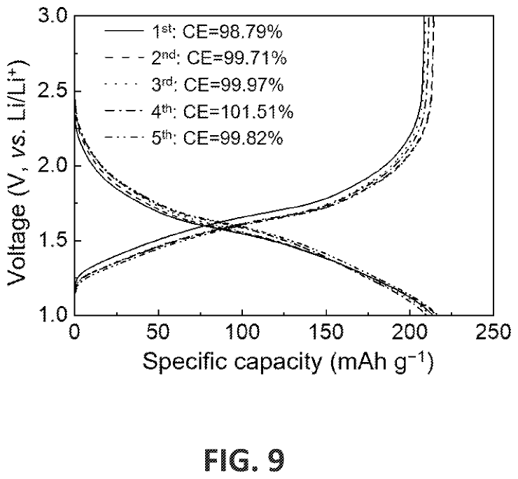

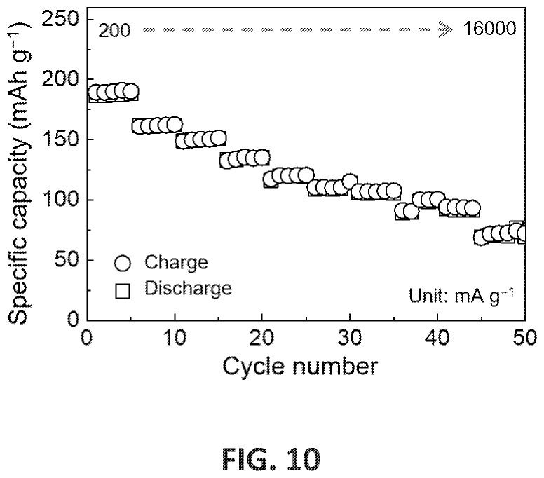

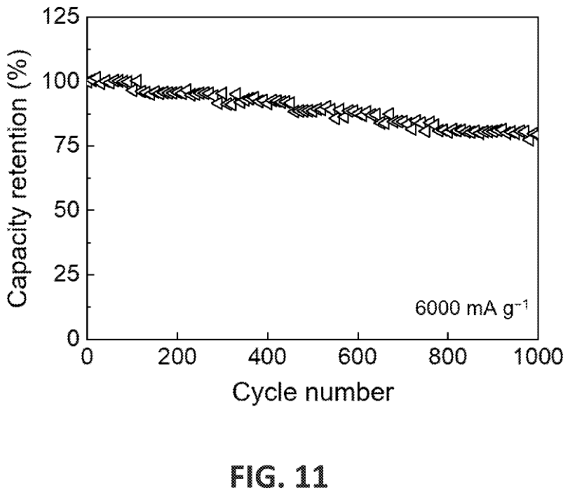

FIG. 9 shows the first five galvanostatic discharge/charge profile together with Coulombic efficiencies of Nb—W—Ti—O-1 electrode. The rate performance of Nb—W—Ti—O-1 electrode is shown in FIG. 10. The cycling performance of Nb—W—Ti—O-1 electrode is shown in FIG. 11.

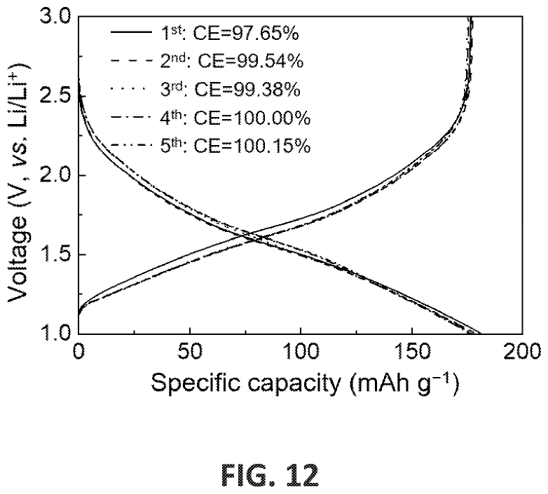

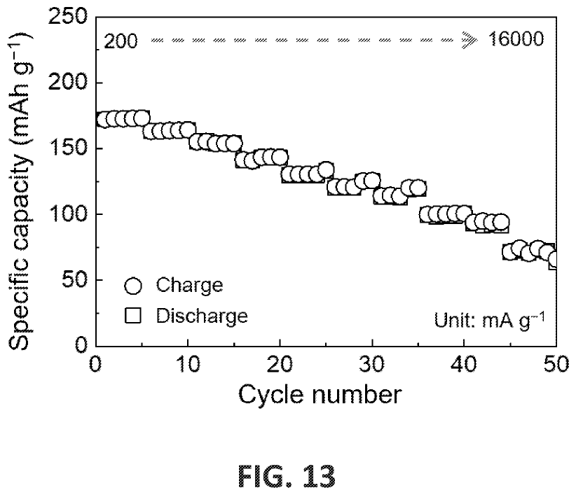

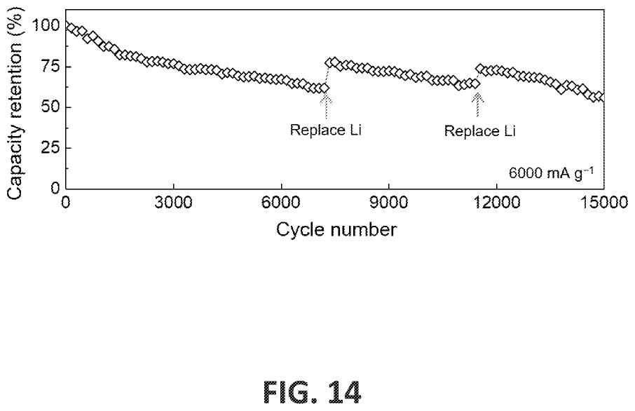

The first five galvanostatic discharge/charge profile together with Coulombic efficiencies of Nb—W—Ti—O-2 electrode is shown in FIG. 12. The rate performance of Nb—W—Ti—O-2 electrode is shown in FIG. 13. The cycling performance of Nb—W—Ti—O-2 electrode is shown in FIG. 14.

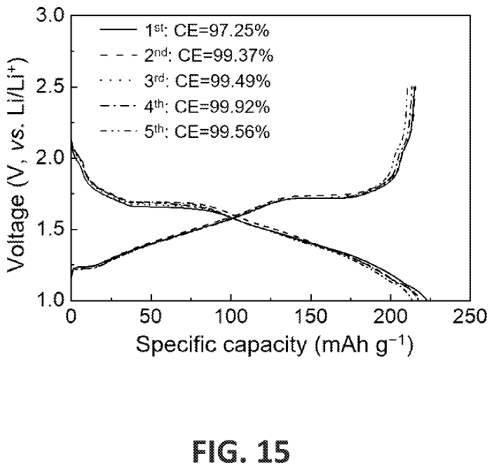

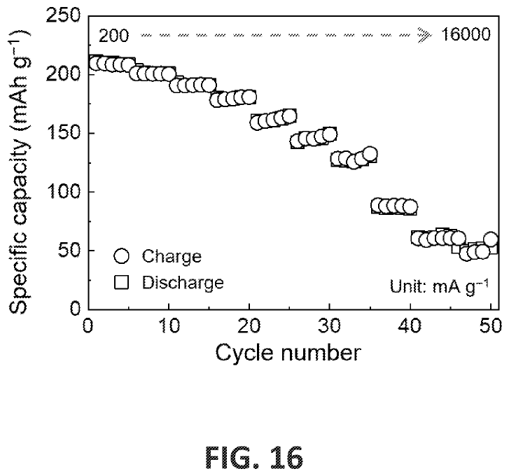

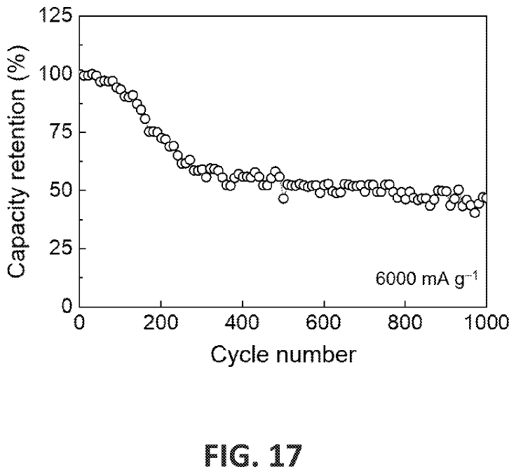

The first five galvanostatic discharge/charge profile together with Coulombic efficiencies of Nb—P—O-1 electrode is shown in FIG. 15. The rate performance of Nb—P—O-1 electrode is shown in FIG. 16. The cycling performance of the Nb—P—O-1 electrode is shown in FIG. 17.

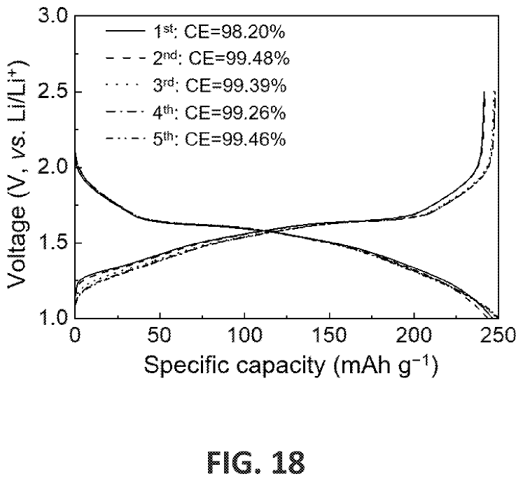

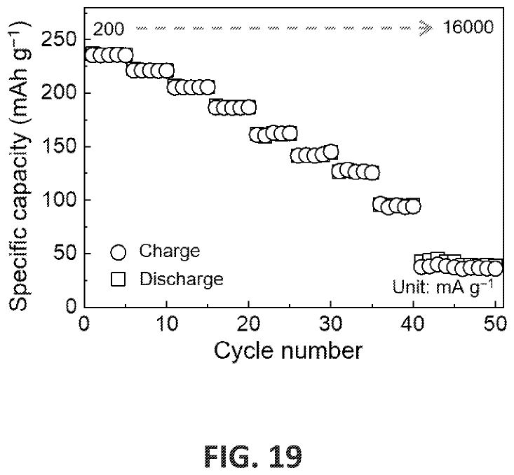

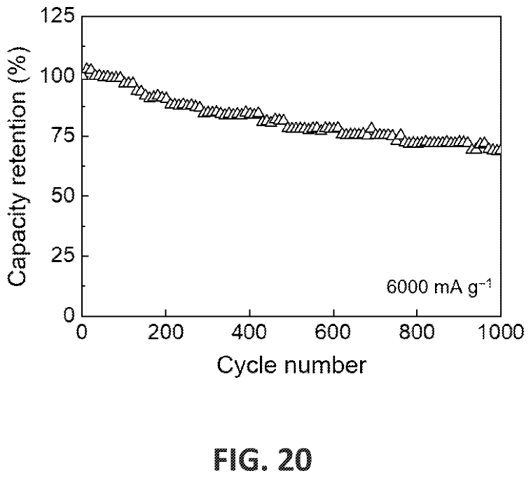

The first five galvanostatic discharge/charge profiles together with Coulombic efficiencies of Nb—Ti—O-1 electrode are shown in FIG. 18. The rate performance of Nb—Ti—O-1 electrode is shown in FIG. 19. The cycling performance of Nb—Ti—O-1 electrode is shown in FIG. 20.

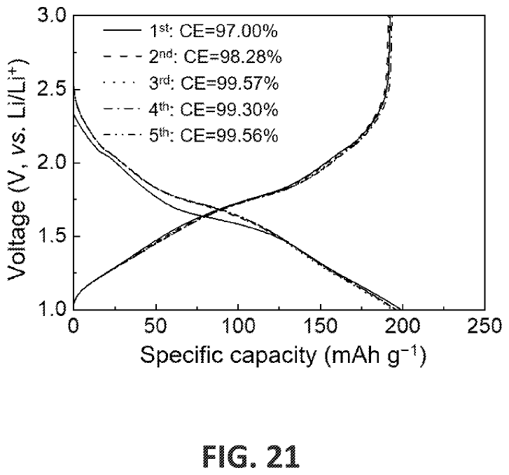

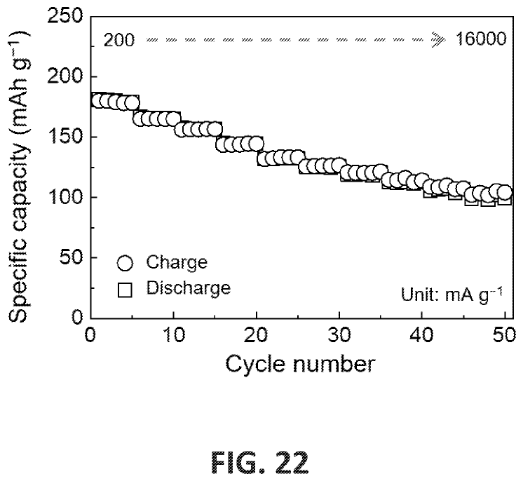

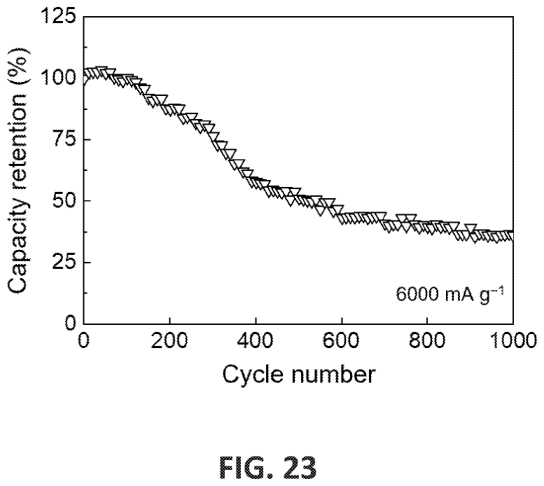

The first five galvanostatic discharge/charge profiles together with Coulombic efficiencies of Nb—W—O-1 electrode are shown in FIG. 21. The rate performance of Nb—W—O-1 electrode is shown in FIG. 22. The cycling performance of Nb—W—O-1 electrode is shown in FIG. 23.

### 5. CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A mixed ionic and electrical conductor (MIEC) material for a battery, the MIEC material comprising:
niobium (Nb) in an amount having a mass percentage from about 0.1% to about 93% relative to the total mass of the MIEC material;
tungsten (W) in an amount having a mass percentage from about 0.1% to about 73% relative to the total mass of the MIEC material;
titanium (Ti) in an amount having a mass percentage from about 0.1% to about 26% relative to the total mass of the MIEC material; and
oxygen (O) in an amount having a mass percentage of about 22% to about 29% relative to the total mass of the MIEC material.

2. The MIEC material of claim 1, wherein the MIEC material has an alkali metal ion diffusivity of at least 10⁻¹⁶ m² s⁻¹.

3. The MIEC material of claim 2, wherein:
the alkali metal ion diffusivity is a lithium ion diffusivity; and
the MIEC material further comprises:
lithium (Li) in an amount having a mass percentage from about 4% to about 12% relative to the total mass of the MIEC material.

4. The MIEC material of claim 1, wherein the MIEC material comprises a plurality of particles consisting essentially of the Nb, the W, the Ti, and the O, each particle of the plurality of particles having a single-crystal structure and at least one dimension that is at least 0.1 μm.

5. The MIEC material of claim 1, further comprising:
at least one of boron (B), nitrogen (N), phosphorous (P), or sulfur (S).

6. The MIEC material of claim 1, further comprising:
carbon (C) in an amount having a mass percentage from about 0.1% to about 20% relative to the total mass of the MIEC material,
wherein:
the MIEC material comprises a plurality of particles consisting essentially of the Nb, the W, the Ti, and the O; and
the C coats the plurality of particles.

7. The MIEC material of claim 1, wherein the MIEC material has a plurality of pores, each pore of the plurality of pores having a pore diameter ranging from about 2.5 Å to about 2.8 Å.

8. The MIEC material of claim 1, wherein:
the MIEC material has a chemical formula of NbₓW_{y}Ti_{z}O_{5x/2+3y+2z};
x is 20-100;
y is 0.1-80; and
z is 0.1-70.

9. The MIEC material of claim 8, wherein the MIEC material has an anion-to-cation ratio (ACR) of (5x/2+3y+2z)/(x+y+z), the ACR ranging from about 2.33 to about 2.80.

10. An anode comprising:
the MIEC material of claim 1,
wherein the MIEC material is present in the anode in an amount having a mass percentage of at least 85% relative to the total mass of the anode.

11. A battery comprising:
the anode of claim 10; and
a cathode comprising at least one of:
LiCoO₂;
LiNi_{0.6}Co_{0.2}Mn_{0.2}O₂;
LiNi_{0.5}Co_{0.2}Mn_{0.3}O₂;
LiNi_{0.33}Co_{0.33}Mn_{0.33}O₂;
LiNi_{0.5}M_{1.5}O₄; or
LiFePO₄.

12. A mixed ionic and electronic conductor (MIEC) material for a battery, the MIEC material comprising:
a first amount of oxygen (O); and
a second amount of metal, the metal comprising niobium (Nb) and at least one of tungsten (W) or titanium (Ti),
wherein:
a ratio of the first amount to the second amount ranges from about 2.33 to about 2.8; and
the MIEC material comprises a plurality of particles consisting essentially of the oxygen and the metal, each particle of the plurality of particles having a single-crystal structure and at least one dimension that is at least 0.1 μm.

13. The MIEC material of claim 12, wherein:
the metal comprises W and Ti; and
the Nb is present in the MIEC material in an amount having a mass percentage from about 0% to about 93% relative to the total mass of the MIEC material;
the W is present in the MIEC material in an amount having a mass percentage from about 0% to about 73% relative to the total mass of the MIEC material;
the Ti is present in the MIEC material in an amount having a mass percentage from about 0% to about 26% relative to the total mass of the MIEC material; and
the O is present in the MIEC material in an amount having a mass percentage of about 22% to about 29% relative to the total mass of the MIEC material.

14. The MIEC material of claim 12, wherein the MIEC material has a plurality of pores, each pore of the plurality of pores having a pore diameter ranging from about 2.5 Å to about 2.8 Å.

15. The MIEC material of claim 12, further comprising:
carbon (C) in an amount having a mass percentage from about 0.1% to about 20% relative to the total mass of the MIEC material, the C coating the plurality of particles.

16. A method of making a mixed ionic and electrical conductor (MIEC) material, the method comprising:
mixing a niobium (Nb) source, a titanium (Ti) source, and a tungsten (W) source to form a mixture; and
heating the mixture to a temperature from about 1000° C. to about 1300° C. for a period from about 0.5 hours to about 60 hours to form the MIEC material, wherein:
the Nb source is at least one of Nb₂O₅, NbO₂, NbC, or niobium ethoxide;
the Ti source is at least one of anatase TiO₂, rutile TiO₂, or TiO₂—B; and
the W source is at least one of WO₃ or WO₂.

17. The method of claim 16, wherein:
Nb is present in the mixture in an amount having a mass percentage from about 0.1% to about 93% relative to the total mass of the mixture;
W is present in the mixture in an amount having a mass percentage from about 0.1% to about 73% relative to the total mass of the mixture; and
Ti is present in the mixture in an amount having a mass percentage from about 0.1% to about 26% relative to the total mass of the mixture.

18. The method of claim 16, wherein the step of heating the mixture forms a plurality of particles consisting essentially of Nb, W, Ti, and oxygen (O) in the MIEC material, each particle of the plurality of particles having a single-crystal structure and at least one dimension that is at least 0.1 μm.

19. The method of claim 16, wherein the step of mixing further comprises:
mixing at least one of a boron (B) source, a nitrogen (N) source, a phosphorous (P) source, or a sulfur (S) source into the mixture.

20. The method of claim 16, wherein:
the step of mixing further comprises:
mixing one or more carbon precursors into the mixture;
the method further comprises:
heating the MIEC material to a temperature from about 200° C. to about 1400° C. for a period from about 0.5 hours to about 12 hours in a control atmosphere consisting essentially of argon (Ar) or nitrogen (N₂) to form a carbon coating on the MIEC material; and
the one or more carbon precursors comprises one or more of graphite, conductive carbon black, carbon nanotubes, carbon nanospheres, carbon nanofibers, carbon gels, sucrose, glucose, fructose, citric acid, ascorbic acid, starch, cellulose, polypropylene, epoxy resin, polyvinylidene fluoride, polytetrafluoroethylene, polystyrene cyanide, phenolic resin, styrene butadiene rubber emulsion, polystyrene, or carboxymethyl cellulose.
